(19) United States
(12) Patent Application Publication
(10) Pub. No.: US 2006/0113757 A1
(43) Pub. Date: Jun. 1, 2006

(54) Headliner restraint systems

(76) Inventors: David Romeo, Thayne, WY (US); Mark Ashley Baldwin, Scottsdale, AZ (US); Gregory Brian Grace, Mesa, AZ (US); Daniel Jay Melcher, Chandler, AZ (US); David Michael Shilliday, Phoenix, AZ (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/002,330

(22) Filed: Dec. 1, 2004

(51) Int. Cl. B60R 21/02

(52) U.S. Cl. 280/730.1; 280/730.2; 280/748

(57) ABSTRACT

Systems for restraining movement of occupants within a vehicle are detailed. Such systems utilize vehicle headliners as parts thereof, with the headliners tensioned to help restrain passenger movement. The headliners may be connected directly or indirectly to inflatable structures typically positioned beneath the headliners. Thus, when the structures inflate, they may generate tension and tend to pull the headliners down from vehicle roofs toward vehicle sides.

### FIELD OF THE INVENTION

This invention relates to devices for protecting vehicle occupants and more particularly (but not exclusively) to restraint systems utilizing vehicle headliners.

### BACKGROUND OF THE INVENTION

U.S. Pat. No. 6,231,072 to Pywell, et al., whose contents are incorporated herein in their entirety by this reference, discloses a restraint assembly including a vehicle headliner. As noted in the Pywell patent, the assembly also includes an air bag positioned between the headliner and roof (and frame) of a vehicle. As the air bag inflates, it causes the headliner to extend downward toward the head and upper torso of a passenger.

In the assemblies of the Pywell patent, the air bag performs a conventional role, acting effectively as an air “mattress” for the vehicle occupant. To do so, it must be positioned so as to intercept an occupant as he or she travels toward an injurious surface (such as the frame or roof of the vehicle). Accordingly, the air bag must be positioned directly behind the headliner, between the head of the occupant and the roof and frame of the vehicle. Although the Pywell patent refers to the headliner as forming “a reactionary surface,” it performs essentially no restraint function in favor of the air bag doing so.

### SUMMARY OF THE INVENTION

The present invention provides alternative restraints to those described in the Pywell patent. Although present systems too utilize vehicle headliners as parts thereof, the headliners function differently than as intended in the Pywell patent. Indeed, rather than merely acting as “reactionary surface[s]” for conventionally-performing air bags, headliners of the present invention themselves help restrain passengers of a vehicle.

Presently preferred embodiments of the invention employ an inflatable structure attached, typically indirectly via a fabric piece, to the headliner. Such inflatable structure need not be positioned intermediate the headliner and the vehicle roof or act as a “mattress,” however. Instead, the inflatable structure beneficially is located below the headliner and functions to tension it, so that the headliner may provide restraint. Or, stated differently, whereas the air bag and headliner apparatus of the Pywell patent requires that the air bag absorb energy by dissipating applied pressure forces, the fabric and headliner of the present invention use tension to reflect the energy away from harmful surfaces.

At least one version of the invention includes an inflatable structure anchored at or near the lower edge of a vehicle window. The structure preferably is tubular when inflated and braided as described in, for example, commonly-owned U.S. Pat. No. 5,322,322 to Bark, et al. and U.S. Pat. No. 6,124,194 to Yaniv, et al. (the contents of both of which patents are incorporated herein in their entireties by this reference). It need not necessarily be so shaped and configured, however. Indeed, in some embodiments, the structure may be knit, for example, rather than braided.

The inflatable structure is adapted to be inflated by any appropriate type of inflation mechanism. A section of (typically non-inflatable) fabric or similar material attaches the inflatable structure to the outboard edge of a vehicle headliner. Thus, when the structure inflates, the tension it generates pulls the headliner down toward the lower edge of the window, creating a protective surface utilizing the membrane tension of the headliner and fabric material.

Systems of the present invention provide numerous advantages over conventional approaches. For example, “closing” of the headliner around an unbelted occupant reduces the area within the vehicle passenger compartment in which the occupant may roam uncontrolled during vehicle rollover. This closure of the passenger compartment by the headliner as well may improve kinematics during side impacts, as the closing headliner operates to decelerate travel of the occupant earlier in time than do traditional head-protection systems.

Systems of the present invention additionally may reduce possibility of occupants being ejected from vehicles during rollover events, regardless of vehicle window sizes. They further may limit exposure of occupants to roof intrusion into the passenger compartment during rollovers. These systems thus advantageously may provide rollover and primary and secondary impact protection with less additional material and less inflated volume than conventional apparatus.

It thus is an optional, non-exclusive object of the present invention to provide restraint systems for occupants of vehicles.

It is another optional, non-exclusive object of the present invention to provide restraint systems involving vehicle headliners.

It is an additional optional, non-exclusive object of the present invention to provide restraint systems in which inflatable components are employed together with the headliners, with the inflatable components not being located between the headliners and roofs of vehicles.

It is also an optional, non-exclusive object of the present invention to provide restraint systems in which the inflatable components are located below the headliners and function, when inflated, to apply tension to the headliners.

It is, moreover, an optional, non-exclusive object of the present invention to provide restraint systems in which an inflatable structure is anchored at or near the lower edge of a vehicle window and which forms, when inflated, a braided tube.

It is a further optional, non-exclusive object of the present invention to provide restraint systems in which fabric or similar material connects the inflatable component with the headliner so that, when the component inflates, it generates tension that pulls the headliner down toward the lower edge of the window.

Other objects, features, and advantages of the present invention will be apparent to those skilled in the relevant field with reference to the remaining text and the drawings of this application.

### BRIEF DESCRIPTION OF THE DRAWINGS

FIGS. 1-7 present various views of an exemplary restraint system of the invention as it deploys.

FIG. 8 provides a view of portions of the system of FIGS. 1-7 stowed prior to deployment.

### DETAILED DESCRIPTION

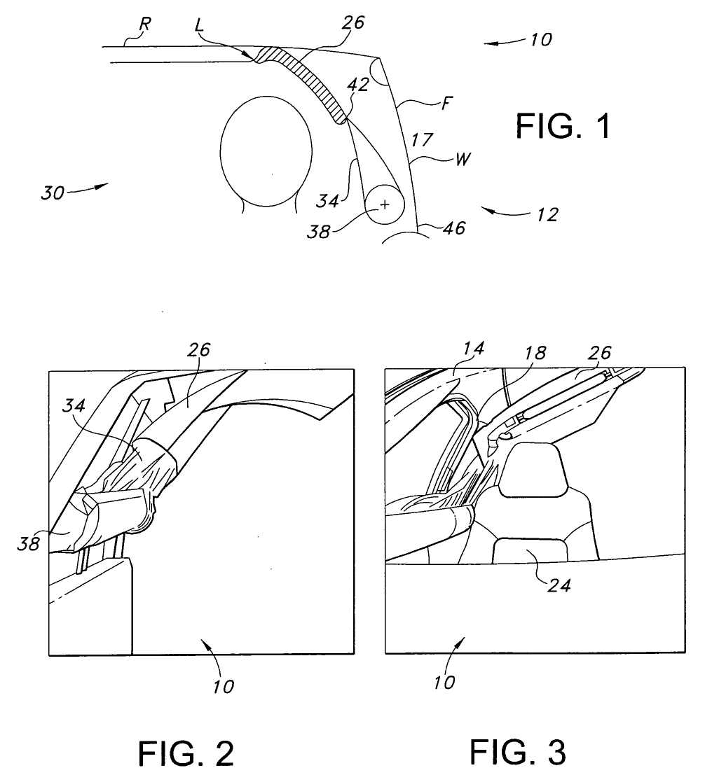

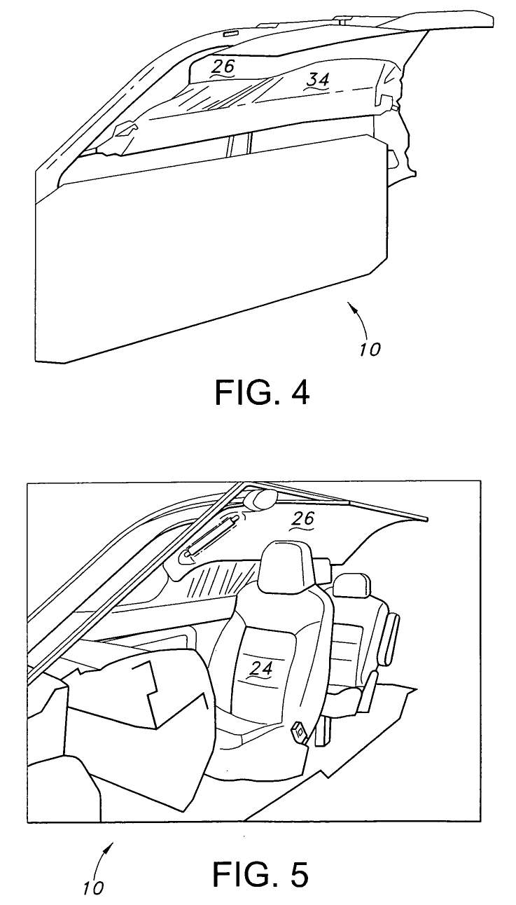

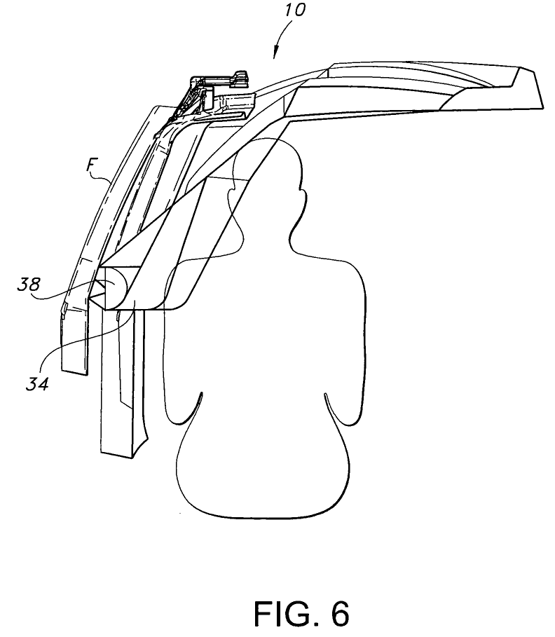

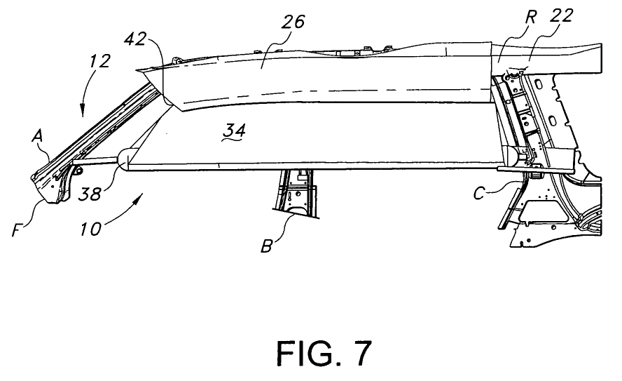

Illustrated in FIGS. 1-8 is system 10 of the present invention. System 10 preferably forms part of a human occupant-protection system for a ground-based vehicle such as an automobile or truck. System 10 is not necessarily so limited, however, and may be employed as well in other vehicles (whether or not ground-based), in other objects or containers likely to be subjected to substantial forces, and to protect (i) animals other than humans or (ii) cargo or other non-living items.

The version of system 10 depicted in FIGS. 1-8 is adapted especially for use in an automobile 12, a portion of which is detailed in the figures. Automobile 12 may comprise frame F including, on each side thereof, pillars A, B, and C. Frame F additionally includes roof R formed with or connected to upper sections 14, 18, and 22 of, respectively, pillars A, B, and C. The region of automobile 12 in which sections 14, 18, and 22 intersect roof R may be denoted a “roof rail.” Automobile 12 typically also includes one or more passenger seats 24 and a headliner 26 which extends from the roof rail on one side of frame F to the roof rail of the other side and is positioned within the passenger compartment 30 immediately below roof R.

Illustrated somewhat schematically in FIG. 1 is a cross-section of portions of system 10. Included as part of system 10 are material 34 and inflatable structure 38. Material 34, which preferably is not inflated, beneficially (but not necessarily) comprises nylon or other fabric. Regardless of composition, material 34 should be designed generally to retain its integrity even when tensioned and subjected to substantial force from impact by the head or torso of an occupant of automobile 12.

Material 34 is connected to headliner 26, typically along edge 42 positioned at or near the roof rail of automobile 12. Material 34 likewise is connected to inflatable structure 38. As noted earlier, structure 38 may comprise a braided or knit component that, when inflated, increases in diameter and decreases in length.

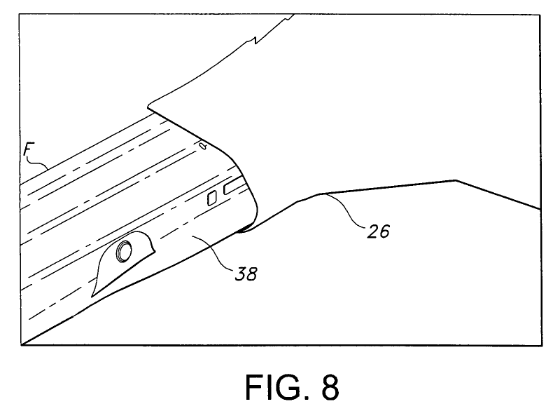

Structure 38 preferably is anchored to pillars A and C of automobile 12 near lower edge 46 of windows W. When not inflated, it may extend from its anchor points along the pillars A and C and the intermediate roof rail. Material 34 likewise may be stowed either along the roof rail or, instead, between headliner 26 and roof R adjacent the roof rail (as shown in FIG. 8).

System 10 additionally may include any mechanism suitable for inflating structure 38 and an initiator for commencing such inflation upon command. Typically the initiator will include a sensor designed to recognize that automobile 12 is being impacted from the side or at an oblique angle. Upon actuation, the inflator inflates structure 38, whose configuration causes it to travel downward toward lower edge 46 and form a taut, semi-rigid structural member across the lower edge 46.

This downward travel of structure 38 pulls connected material 34 downward too, so that material 34 covers at least portions of windows W and, perhaps, pillar B. Material 34, in turn, pulls edge 42 of headliner 26 downward. Because structure 38 is anchored and semi-rigid and headliner 26 is anchored elsewhere along the roof R, inflating structure 38 tensions material 34 and headliner 26 in an area between occupant H and frame F.

Material 34 may be connected to headliner 26 and structure 38 in any appropriate manners. FIGS. 1 and 6-7 especially illustrate material 34 wrapping around the (tubular) structure 38 to supply the connection, effectively acting as a sling. Alternatively, material 34 may be sewn onto or into structure 38 or otherwise fastened or attached thereto. Similarly, although material 34 preferably is sewn onto or into headliner 26, other connection means may be employed instead.

Although capable of use with conventional headliners 26, operation of system 10 may benefit in some instances from modification to such conventional headliners 26. For example, headliners 26 could be modified so as to bend along selected longitudinal lines (as shown at point L of FIG. 1). Likewise, system 10 could substitute a conventional air bag for inflatable structure 38. Finally, system 10 could, if desired, directly connect inflatable structure 38 (or an air bag) to headliner 26, avoiding the need for material 34.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention.

What is claimed is:

1. Protective device for an occupant of a vehicle having a roof and a headliner therefor, the roof being above the occupant when the vehicle is upright, the protective device comprising means for pulling the headliner down toward the occupant as a result of a predefined event.

2. Protective device according to claim 1 in which the pulling means comprises a deployable structure anchored to the vehicle below the headliner when the vehicle is upright and connected directly or indirectly to the headliner.

3. Protective device according to claim 2 in which deploying the deployable structure tensions the headliner.

4. Protective device according to claim 3 in which the deployable structure inflates when deployed.

5. Protective device for an occupant of a vehicle having a roof and a headliner therefor, the protective device comprising an inflatable structure (a) anchored to the vehicle below the headliner when the vehicle is upright, (b) connected directly or indirectly to the headliner, and, (c) when inflated and the vehicle is upright, configured to pull the headliner down.

6. Protective device according to claim 5 further comprising a non-inflatable material connected to the headliner and to the inflatable structure.

7. Protective device according to claim 6 in which the inflatable structure is connected indirectly to the headliner via the non-inflatable material.

8. Protective device according to claim 5 in which, when inflated, the inflatable structure tensions the headliner.

9. Protective device according to claim 5 in which the inflatable structure forms a semi-rigid tube when inflated.

10. Protective device according to claim 9 in which the inflatable structure is braided or knit.

11. Protective device according to claim 6 in which, when inflated, the inflatable structure tensions the headliner and the non-inflatable material.

12. Protective device according to claim 6 in which the non-inflatable material is connected to the inflatable structure by wrapping the non-inflatable material around at least a portion of the inflatable structure.

13. Protective device according to claim 5 further comprising means for inflating the inflatable structure.

14. Protective device according to claim 5 in which the inflatable structure pulls the headliner down so that the headliner bends along a defined axis.

15. Protective device according to claim 6 in which at least some of the non-inflatable material is stowed between the headliner and the roof of the vehicle prior to inflation of the inflatable structure.

16. Protective device according to claim 11 in which, when tensioned, the headliner and the non-inflatable material absorb energy of the occupant when the vehicle is impacted from the side or at an oblique angle to forward direction of travel of the vehicle.

17. A vehicle comprising the protective device of claim 1.

18. A method of deploying a protective device in a vehicle having a seat in which an occupant sits, the method comprising activating a structure anchored to the vehicle below a headliner to which it directly or indirectly is connected and, by virtue of activating the structure, pulling the headliner down and tensioning it so as to present an energy-absorbing surface which the occupant may contact.

19. A method according to claim 18 in which activating the structure comprises inflating the structure.
